(19) United States
(12) Patent Application Publication
(10) Pub. No.: US 2021/0209625 A1
(43) Pub. Date: Jul. 8, 2021

(54) DEMAND FORECASTING WITH LARGE COLLECTIONS OF TIME SERIES DATA

(71) Applicant: International Business Machines Corporation, Armonk, NY (US)

(72) Inventors: John Jai Thomas, Fishkill, NY (US); Aakanksha Joshi, Jersey City, NJ (US); Vinay Rao Dandin, San Jose, CA (US)

(21) Appl. No.: 16/733,054

(22) Filed: Jan. 2, 2020

(51) Int. Cl. G06Q 30/02; G06N 5/04

(52) U.S. Cl. CPC G06Q 30/0202; G06N 5/04

(57) ABSTRACT

Demand forecasting in which sets of first order differences are determined for collections of time series data for products. The first order differences identify how values within the collections of time series data change over time. The sets of first order differences are normalized to form sets of scaled first order differences such that a same scale is present between the scaled first order differences. Bins with dynamic ranges are determined for the scaled first order differences based on a distribution of the scaled first order differences; The scaled first order differences are placed into the bins to form sets of binned values in which binned values in the sets of binned values are based on numbers of scaled first order differences in the bins. The time series data are grouped into segments based on a correlation between the sets of binned values for the time series data.

### BACKGROUND

### 1. Field

The disclosure relates generally to an improved computer system and, more specifically, to a method, apparatus, system, and computer program product for demand forecasting of products.

### 2. Description of the Related Art

Knowing a future demand for a product is desirable when planning for manufacturing of products or purchasing products for resale. Demand forecasting can be used to predict future demand for products. Demand forecasting is a process in which historical sales data for a product can be used to determine a forecast of customer demand for that product. This type of forecasting can be used to estimate an amount of product, such as goods and services, which customers may purchase at a future point in time.

Time series analysis is commonly used in demand forecasting of individual products. Time series analysis involves analyzing time series data, which are series of points indexed in a time order. This analysis can be used to create forecasting models that predict future values such as demand for products.

### SUMMARY

According to one embodiment of the present invention, a method for demand forecasting is present. Sets of first order differences are determined by a computer system for time series data within collections of time series data for products. The sets of first order differences identify how values in the time series data within the collections of time series data change over time. The sets of first order differences for the time series data are normalized by the computer system to form sets of scaled first order differences such that a same scale is present between the sets of scaled first order differences. Bins with dynamic ranges are determined by the computer system for the sets of scaled first order differences, wherein dynamic ranges are based on a distribution of the sets of scaled first order differences. The sets of scaled first order differences are placed into the bins by the computer system to form sets of binned values for the collections of time series data in which binned values in the sets of binned values are based on a number of scaled first order differences in the bins. The collections of time series data for the products are grouped into segments by the computer system based on a correlation between the sets of binned values for the collections of time series data.

According to another embodiment of the present invention, a demand forecasting system comprises a computer system. The computer system operates to determine sets of first order differences for time series data within collections of time series data for products. The sets of first order differences identify how values in the time series data within the collections of time series data change over time. The computer system normalizes the sets of first order differences for the time series data to form sets of scaled first order differences such that a same scale is present between the sets of scaled first order differences. The computer system determines bins with dynamic ranges for the sets of scaled first order differences, wherein the dynamic ranges are based on a distribution of the sets of scaled first order differences. The computer system places the sets of scaled first order differences into the bins to form sets of binned values for the collections of time series data in which binned values in the sets of binned values are based on a number of scaled first order differences in the bins. The computer system groups the collections of time series data for the products into segments based on a correlation between the sets of binned values for the collections of time series data.

According to yet another embodiment of the present invention, a computer program product for demand forecasting comprises a computer-readable storage media with first program code, second program code, third program code, fourth program code, and fifth program code stored on the computer-readable storage media. The first program code is executable by a computer system to cause the computer system to determine sets of first order differences for time series data within collections of time series data for products. The sets of first order differences identify how values in the time series data within the collections of time series data change over time. The second program code is executable by the computer system to cause the computer system to normalize the sets of first order differences for the time series data to form sets of scaled first order differences such that a same scale is present between the sets of scaled first order differences. The third program code is executable the computer system to cause the computer system to determine bins with dynamic ranges for the sets of scaled first order differences, wherein the dynamic ranges are based on a distribution of the sets of scaled first order differences. The fourth program code is executable by the computer system to cause the computer system to place the sets of scaled first order differences into the bins to form sets of binned values for the collections of time series data in which binned values in the sets of binned values are based on a number of scaled first order differences in the bins. The fifth program code is executable by the computer system to cause the computer system to group the collections of time series data for the products into segments based on a correlation between the sets of binned values for the collections of time series data.

### BRIEF DESCRIPTION OF THE DRAWINGS

FIG. 1 is a block diagram of a forecasting environment in accordance with an illustrative embodiment;

FIG. 2 is an illustration of a process for generating bins with dynamic ranges in accordance with an illustrative embodiment;

FIG. 3 is an illustration of parts under a distribution curve for determining dynamic ranges of bins in accordance with an illustrative embodiment;

FIG. 4 is an illustration of bins with panic ranges in accordance with an illustrative embodiment;

FIG. 5 is a flowchart of a process for demand forecasting in accordance with an illustrative embodiment;

FIG. 6 is a flowchart of a process for grouping collections of time series data into segments in accordance with an illustrative embodiment;

FIG. 7 is a flowchart of a process for creating a forecasting model from an initial collection of time series data in accordance with an illustrative embodiment;

FIG. 8 is a flowchart of a process for creating bins with dynamic ranges in accordance with an illustrative embodiment; and

FIG. 9 is a block diagram of a data processing system in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account a number of different considerations. For example, the illustrative embodiments recognize and take into account that many challenges are present in demand forecasting when dealing with a large number of products. For example, the illustrative embodiments recognize and take into account issues such as how can noise be reduced and the amount of input with dealing with a large number of products are present. Further, the illustrative embodiments also recognize and take into account that the question of how to scale a forecasting solution to large numbers of products, such as tens of thousands of products, is present.

The illustrative embodiments recognize and take into account that a forecasting model can be created for each product. The illustrative embodiments recognize and take into account that creating a model for each product can be infeasible with respect to the amount of time and effort.

The illustrative embodiments recognize and take into account that a forecasting model can be created for all of the products of interest. The illustrative embodiments recognize and take into account that grouping all of the products together to create a model can result in the model having too much noise in the input data. As a result, the illustrative embodiments recognize and take into account that this type of model can fail to recognize different patterns more often than desired.

Therefore, it would be desirable to have a method and apparatus that take into account at least some of the issues discussed above, as well as other possible issues. For example, it would be desirable to have a method and apparatus that overcome a technical problem with grouping collections of time series data to perform demand forecasting for large numbers of products.

The illustrative embodiments recognize and take into account that collections of time series data for products can be grouped into multiple groups, also referred to as segments. A forecasting model can be created for each segment. The illustrative embodiments recognize and take into account that currently used methodologies for creating segments of time series data result in low silhouette scores. In other words, the similarity between collections of time series data in a segment may not be as high as desired. A set of forecasting models are then built. One forecasting model is created for each segment.

Thus, the illustrative embodiments provide a method, apparatus, system, and computer program product for grouping time series data into segments for generating forecast models. In one illustrative example, a method is present for demand forecasting.

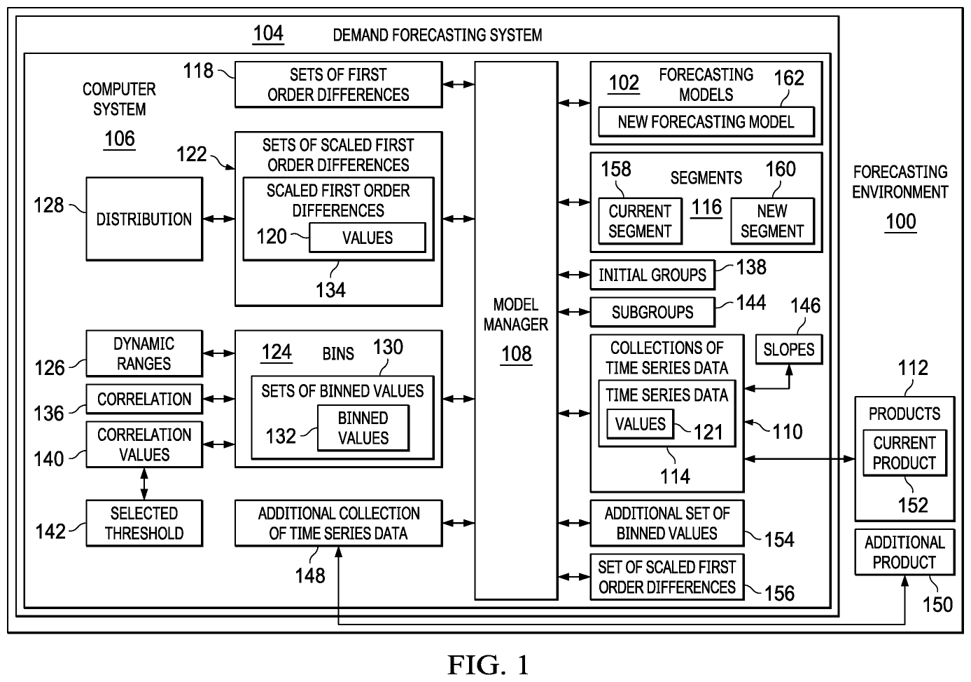

With reference now to the figures and, in particular, with reference to FIG. 1, a block diagram of a forecasting environment is depicted in accordance with an illustrative embodiment. In this illustrative example, forecasting environment 100 is an environment in which forecasting models 102 are used in predictions such as demand forecasting. In this illustrative example, demand forecasting system 104 operates to create forecasting models 102.

As depicted, demand forecasting system 104 comprises computer system 106 and model manager 108. Model manager 108 is located in computer system 106.

Model manager 108 can be implemented in software, hardware, firmware, or a combination thereof. When software is used, the operations performed by model manager 108 can be implemented in program code configured to run on hardware, such as a processor unit. When firmware is used, the operations performed by model manager 108 can be implemented in program code and data and stored in persistent memory to run on a processor unit. When hardware is employed, the hardware may include circuits that operate to perform the operations in model manager 108.

In the illustrative examples, the hardware may take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components, excluding a human being. For example, the processes can be implemented as circuits in organic semiconductors.

Computer system 106 is a physical hardware system and includes one or more data processing systems. When more than one data processing system is present in computer system 106, those data processing systems are in communication with each other using a communications medium. The communications medium can be a network. The data processing systems can be selected from at least one of a computer, a server computer, a tablet computer, or some other suitable data processing system.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, model manager 108 in computer system 106 operates to create forecasting models 102 from collections of time series data 110 for products 112. A collection of time series data in collections of time series data 110 is time series data for a product in products 112. In this illustrative example, each collection of time series data corresponds to a product. As depicted, a product in products 112 can be a service, an item, and combinations thereof. Products 112 can include both good and services. A product in products 112 can include both goods and services. For example, a product can include an item such as software or a vehicle, and the service can be support for the software or vehicle that is a part of the product.

In this illustrative example, time series data 114 in collections of time series data 110 is a series of data points that are indexed in a time order. Collections of time series data 110 can be processed by model manager 108 to generate forecasting models 102. Each forecasting model can predict the future value of items such as demand for a product in products 112.

In this illustrative example, model manager 108 can group collections of time series data 110 into segments 116. As depicted, each segment can include one or more collections of time series data 110. Each segment in segments 116 can be used to create a forecasting model in forecasting models 102.

As depicted, model manager 108 determines sets of first order differences 118 for time series data 114 within collections of time series data 110 for products 112. In this illustrative example, sets of first order differences 118 identify how values 121 in time series data 114 within collections of time series data 110 change over time. In other words, scaled first order differences 134 indicate how values 121 are changing from time period to time period in time series data 114. In this illustrative example, the changes can be from one period of time to a prior or subsequent period of time. In other words, a first order difference is the change in value from one data point to an adjacent data point in time series data 114.

In this illustrative example, model manager 108 normalizes sets of first order differences 118 for time series data 114 to form sets of scaled first order differences 122. The normalization can be performed such that a same scale is present between sets of scaled first order differences 122.

Further, model manager 108 determines bins 124 with dynamic ranges 126 for sets of scaled first order differences 122. In this illustrative example, dynamic ranges 126 are based on distribution 128 of sets of scaled first order differences 122. As depicted, distribution 128 is the distribution of values 120 in sets of scaled first order differences 122. For example, dynamic ranges 126 are selected to optimize an outcome of a set of variables under a set of constraints in a decision optimization model such that changes in first order differences greater than a threshold are isolated by bins 124.

The threshold can be selected based on when changes have a standard deviation that is greater than some desired amount. The threshold can be used to isolate extreme changes in scaled first order differences 134 in sets of scaled first order differences 122 when scaled first order differences 134 are placed into bins 124. The isolation can be such that these changes in scaled first order differences 134 are located in one or more bins in bins 124 that separate these undesired values from other values of scaled first order differences 134.

Model manager 108 places sets of scaled first order differences 122 into bins 124 to form sets of binned values 130 for collections of time series data 110 in which binned values 132 in sets of binned values 130 are based on a number of scaled first order differences 134 in bins 124. In the illustrative example, binned values 132 in a bin in bins 124 form a set of binned values in sets of binned values 130. In other words, each set of binned values in sets of binned values 130 corresponds to a bin in bins 124.

In this illustrative example, model manager 108 groups collections of time series data 110 for products 112 into segments 116 based on correlation 136 between sets of binned values 130 for collections of time series data 110. In this illustrative example, model manager 108 can perform grouping of time series data 110 into segments 116 in a number of different ways.

In the illustrative example, model manager 108 groups collections of time series data 110 for products 112 into initial groups 138 based on correlation values 140 for sets of binned values 130 for collections of time series data 110 being within selected threshold 142 of each other. Model manager 108 can then create subgroups 144 from initial groups 138 based on slopes 146 for collections of time series data 110 in initial groups 138. Subgroups 144 form segments 116. In the illustrative example, each collection of time series data can be analyzed to determine a slope for the collection of time series data. In the illustrative example, slopes 146 can have positive values or negative values. These values of the slopes can be used to determine which subgroup a collection of time series data is placed from an initial group in initial groups 138.

Model manager 108 can create forecasting models 102 for products 112 from segments 116 in which collections of time series data 110 are located. The different steps performed by model manager 108 in computer system 106 can reduce the noise present when creating forecasting models 102 from segments 116 of collections of time series data 110.

In one illustrative example, one or more solutions are present that overcome a problem with at least one of noise or accuracy issues involved with current segmenting of time series data to create forecasting models. As a result, one or more solutions described in the illustrative examples may provide an effect of providing an automated process for segmenting time series data in a manner that reduces noise, increases accuracy, or both reduces noise and increases accuracy of forecasting models 102. With the illustrative example, prior knowledge of what signals should be expected in the data is not needed. For example, if 2,000 products in 1,500 unique signals are present, employing a K-means iteration from 1 through 2,000 in identifying the ideal 1,500 number of clusters is impractical with current techniques.

Thus, in the illustrative example, the first order difference is extracted to determine how the values are changing from time period to time period instead of just comparing across absolute values as with current techniques. Further, the illustrative example normalizes these values to express their relative magnitude of change over time. The first order differences are then placed into bins using dynamic range binning in an automated fashion to isolate the extreme changes in the time series. The dynamic range of bins can be determined dynamically by selecting sizes for the bins to achieve desired results such as isolating changes that are greater than desired in the collections of time series data as determined from sets of scaled first order differences. Further, the binning of data in bins with dynamic ranges also can be used to reduce the granularity of the data. The correlation between the binned data is determined, and products that have a desirable correlation can be grouped into segments for use in building forecasting models on a per segment basis.

Further, the illustrative examples can also introduce time series data for new products or other products not originally considered in generating forecasting models 102. For example, model manager 108 can identify additional collection of time series data 148 for additional product 150. Model manager 108 can identify current product 152 in products 112 with a set of binned values in sets of binned values 130 having a highest correlation to additional set of binned values 154 for set of scaled first order differences 156 for additional collection of time series data 148.

As depicted, model manager 108 can place additional collection of time series data 148 into current segment 158 for current product 152 in segments 116 when the highest correlation is within a threshold. Model manager 108 can place additional collection of time series data 148 into new segment 160 when the highest correlation is not within the threshold. The threshold can be selected based on the collection of time series data available. Factors include, for example, how correlated two time series should be for inclusion in the same segment based on the domain. For example, a default value for correlation can be 0.8.

As depicted, model manager 108 can create new forecasting model 162 for collections of time series data 110 in current segment 158 when additional collection of time series data 148 is placed into current segment 158.

Model manager 108 can create new forecasting model 162 for additional collection of time series data 148 in new segment 160 when additional collection of time series data 148 is placed into new segment 160.

In the illustrative examples, collections of time series data 110 for products 112 grouped into segments 116 can have at least one of less noise or an increased accuracy as compared to current techniques used to create segments from time series data for products.

Computer system 106 can be configured to perform at least one of the steps, operations, or actions described in the different illustrative examples using software, hardware, firmware, or a combination thereof. As a result, computer system 106 operates as a special purpose computer system in which model manager 108 in computer system 106 enables segmenting collections of time series data in a manner that at least one of reduces noise or increases accuracy in predicting demand for products. In particular, model manager 108 turns computer system 106 into a special purpose computer system as compared to currently available general computer systems that do not have model manager 108.

The illustration of forecasting environment 100 in FIG. 1 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, demand forecasting system 104 is directed towards generating forecasting models 102 that can be used to perform demand forecasting. The illustrative examples can be applied to other uses. For example, model manager 108 can be used to create models for applications selected from at least one of clustering, association mining, pattern matching, or other suitable applications.

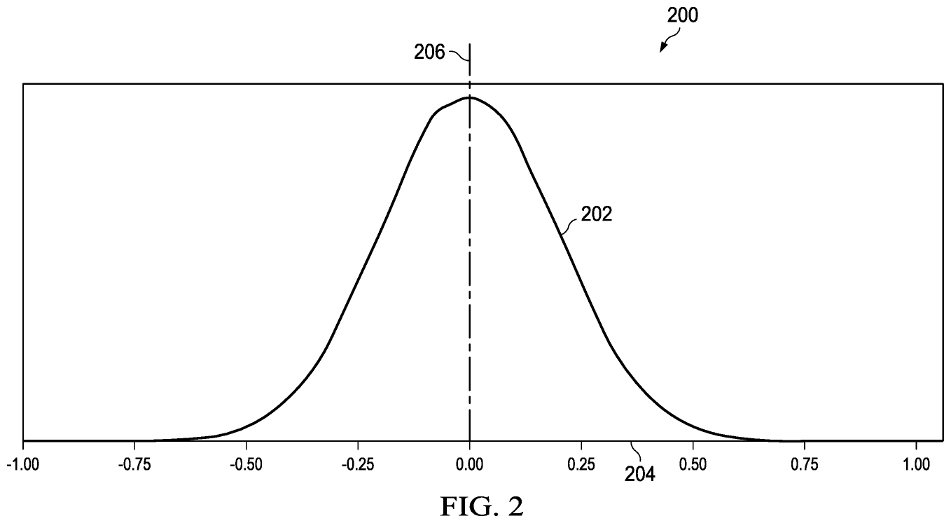

Turning next to FIG. 2, an illustration of a distribution curve is depicted in accordance with an illustrative embodiment. As depicted, graph 200 has distribution curve 202 shown on x-axis 204 and y-axis 206. In this illustrative example, x-axis 204 represents scaled first order differences in sets of scaled first order differences for collections of time series data for products. In this depicted example, y-axis 206 represents the number of first order differences for a particular scaled value on x-axis 204 for the collections of time series data for the products.

Distribution curve 202 can be divided into bins in which the bins have ranges that are dynamically selected. For example, distribution curve 200 can be divided into six parts for six bins. In this illustrative example, symmetrical divisions can be used in which the symmetrical divisions have a symmetry about y-axis 206. With six bins, distribution curve 202 can be divided into six parts with three parts on each side of y-axis 206. Each side of y-axis 206 can have additional symmetry in which the bins around the central bin contain equal data distribution. In this illustrative example, the six bins can be −3, −2, −1, 1, 2, and 3.

In this illustrative example, the number of variables used to determine dynamic ranges are identified as followed when symmetry is present:

number_variables=int(ceiling((bins/2)/2).

As depicted, ceiling(x) is a ceiling function which takes a real number x and outputs an integer that is greater than or equal to x. In other words, the ceiling function rounds up to the nearest energy. In this example, int(x) is an integer function that takes the real number x and outputs an integer that is less than or equal to x. In other words, the integer function rounds a real number down to the nearest integer.

In this example, for six bins, the number variables, number_variables, is 2. The variables are w1 and w2 in this example.

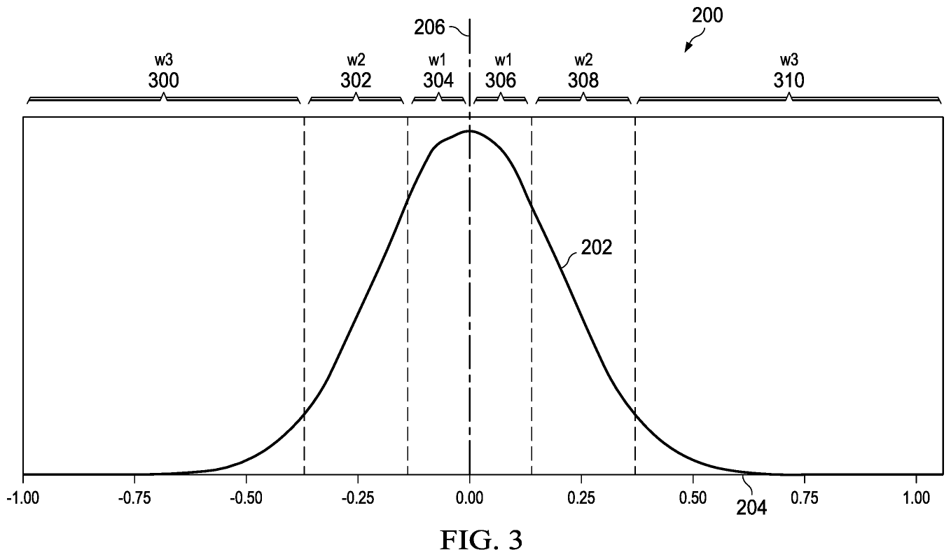

Turning now to FIG. 3, an illustration of parts under a distribution curve for determining dynamic ranges of bins is depicted in accordance with an illustrative embodiment. As depicted, graph 200, having distribution curve 202, can be divided up into six sections in which three sections are present on each side of y-axis 206. The sections are symmetrical about y-axis 206 in this example.

The variables w1 and w2 represent the distribution of data points from the sets of scaled first order differences that fall within section 300, section 302, section 304, section 306, section 308, and section 310. In this example, w1 and w2 represent the ratios of data adding up to 3 such that w1+w2+w3=3 on each side of y-axis 206.

Current techniques can assign 33 percent of the data to each of these variables and let the variables take the value of 1. In contrast, values can be dynamically assigned to the variables in the illustrative example.

In this illustrative example, the equation is solved to isolate changes in scaled first order differences that may be large enough to be undesirable. These types of changes can be made for extreme changes for the scaled first order differences.

The difference between w2 and w1 are maximized subject to constraints. In the illustrative example, the constraints are generally modeled based on the desired outcome to be achieved. In this illustrative example, the constraints are, for example, w2−w1>=0; w1>=0.1; and w2*sqrt(stdev)=1.

As depicted, the constraint w2−w1>=0 is used to isolate the changes in the scaled first order differences that are considered to be extreme. This constraint can be used to keep maximum or larger parts of the distribution towards the middle, which is around y-axis 206.

In this depicted example, the constraint w1>=0.1 avoids corner distributions being smaller than desired. With a desire to make the value of w1 smaller, the model is instructed to not use zero or a value that is considered extremely small. For example, w1 can be set to equal 0.10. This value means that at least 0.2 parts of 3 should go into bins for w1.

As depicted, the constraint w2*sqrt(stdev)=1 takes into account that, as the standard deviation becomes smaller, distribution curve 202 also becomes narrower, which may contain more erratic values. This constraint can be used to isolate the changes in the scaled first order differences that are considered to be larger or more extreme than desired. In this manner, more data is incorporated by the variable w2 and vice versa.

Once the optimization problem is solved, the solution (ratios of 3) can be used to calculate all the areas under distribution curve 202 (ratios of 6, percentage).

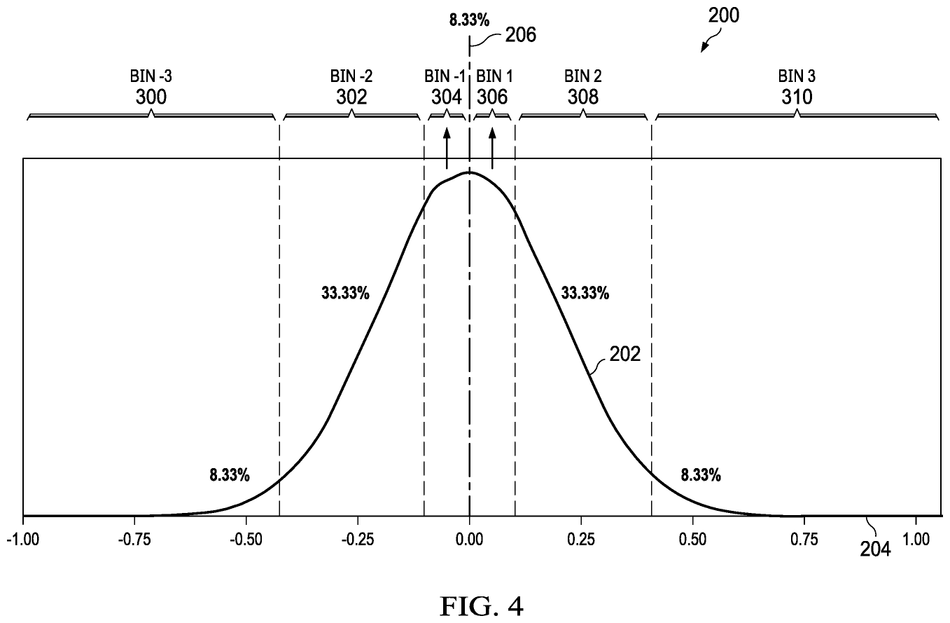

With reference now to FIG. 4, an illustration of bins with panic ranges is depicted in accordance with an illustrative embodiment. For example, one possible solution is to get w1=0.5 and w2=2.0, then:

0.5/6*100=8.33% of data in bin −3 in section 300, bin −1 in section 304, bin 1 in section 306, and bin 3 in section 310.

2/6*100=33.33% of data in bin −2 in section 302 and bin +2 in section 308.

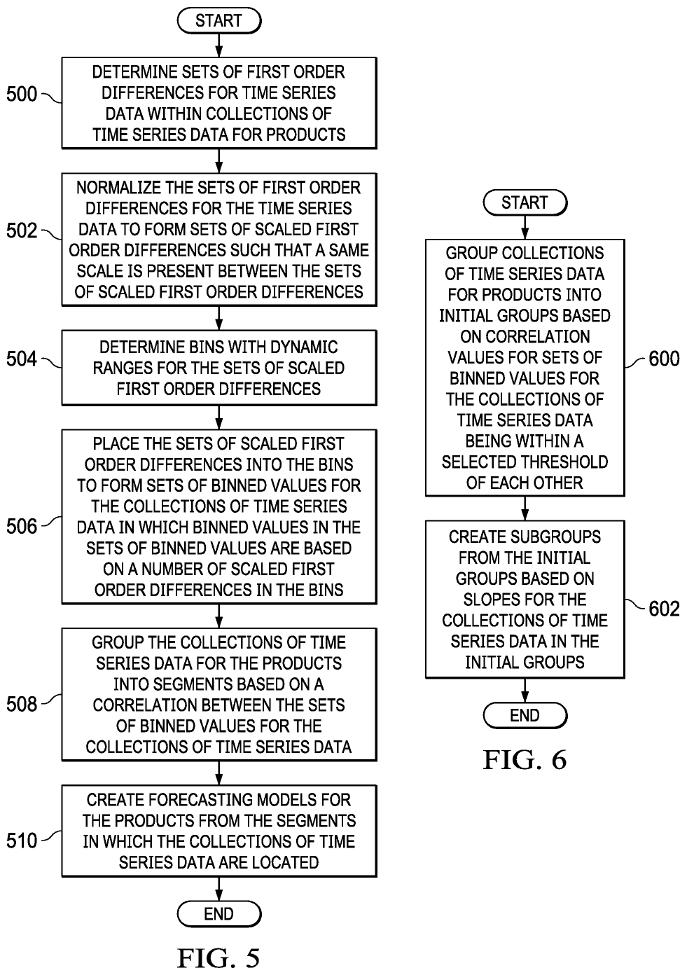

Turning next to FIG. 5, a flowchart of a process for demand forecasting is depicted in accordance with an illustrative embodiment. The process in FIG. 5 can be implemented in hardware, software, or both. When implemented in software, the process can take the form of program code that is run by one or more processor units located in one or more hardware devices in one or more computer systems. For example, the process can be implemented in model manager 108 in computer system 106 in FIG. 1.

The process begins by determining sets of first order differences for time series data within collections of time series data for products (step 500). The sets of first order differences in step 500 identify how values in the time series data within the collections of time series data change over time. The process normalizes the sets of first order differences for the time series data to form sets of scaled first order differences such that a same scale is present between the sets of scaled first order differences (step 502).

The process determines bins with dynamic ranges for the sets of scaled first order differences (step 504). The dynamic ranges in step 504 are based on a distribution of the sets of scaled first order differences. In one illustrative example, the dynamic ranges are selected to optimize an outcome of a set of variables under a set of constraints in a decision optimization model such that changes in first order differences greater than a threshold are isolated by the bins. Thus, the range or size of each bin can be determined based on the sets of scaled first order differences for the collections of time series data. In other words, the sizes of the bins are not predetermined but instead based on the analysis of the time series data.

The process places the sets of scaled first order differences into the bins to form sets of binned values for the collections of time series data in which binned values in the sets of binned values are based on a number of scaled first order differences in the bins (step 506). In step 506, the scaled values for the changes in the collections of time series data are placed into the bins. The process groups the collections of time series data for the products into segments based on a correlation between the sets of binned values for the collections of time series data (step 508). In step 508, the process determines correlations between the different sets of bin values. Correlations are determined between all the time series in the same collection itself. For example, when two collections of time series data are present, the correlations are determined between first binned values for a first collection of time series data and second binned values for a second collection of time series data. When three collections of time series data are present, the correlations are determined between the first binned values for a first collection of time series data and the second binned values for second collections of time series data, and between the first binned values for the first collection of time series data and third binned values for a third collection of time series data. The correlations are also determined between the second binned values for the second collection of time series data and the third binned values for the third collections of time series data such that the correlations are determined between all of the collections of time series data.

The process creates forecasting models for the products from the segments in which the collections of time series data are located (step 510). In this example, the products in the same segment will have the same forecasting model. The process terminates thereafter.

With reference next to FIG. 6, a flowchart of a process for grouping collections of time series data into segments is depicted in accordance with an illustrative embodiment. The process illustrated in FIG. 6 is an example of one implementation for step 508 in FIG. 5.

The process begins by grouping collections of time series data for products into initial groups based on correlation values for sets of binned values for the collections of time series data being within a selected threshold of each other (step 600). The process creates subgroups from the initial groups based on slopes for the collections of time series data in the initial groups (step 602). The process terminates thereafter. The subgroups created in step 602 form the segments.

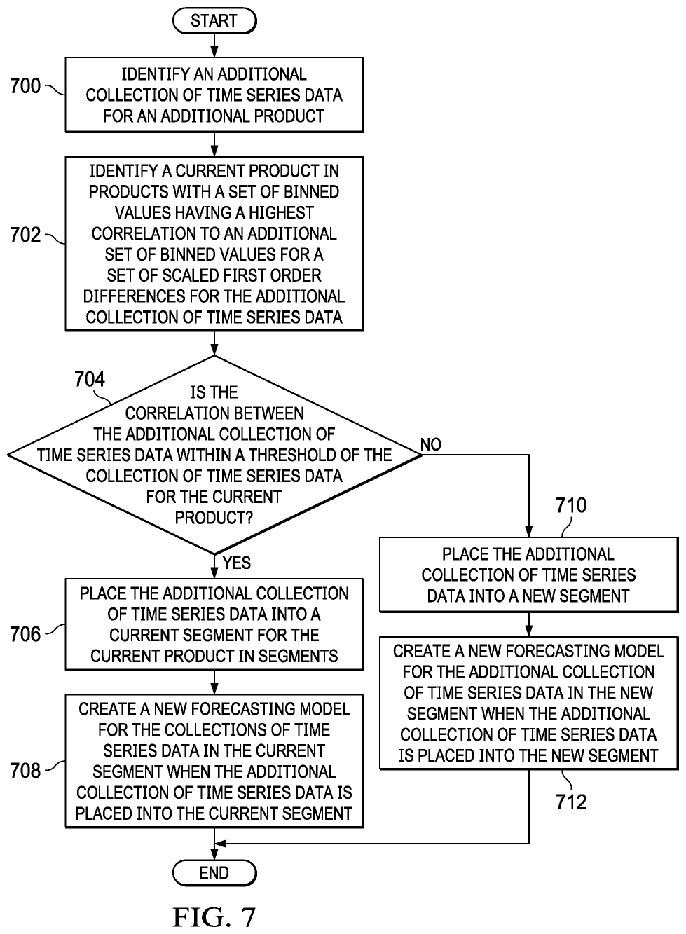

Turning now to FIG. 7, a flowchart of a process for creating a forecasting model from an initial collection of time series data is depicted in accordance with an illustrative embodiment. The process in FIG. 7 can be implemented in hardware, software, or both. When implemented in software, the process can take the form of program code that is run by one or more processor units located in one or more hardware devices in one or more computer systems. For example, the process can be implemented in model manager 108 in computer system 106 in FIG. 1. This process can be performed after collections of time series data have been processed and segmented for creating forecasting models.

The process begins by identifying an additional collection of time series data for an additional product (step 700). The process identifies a current product in products with a set of binned values having a highest correlation to an additional set of binned values for a set of scaled first order differences for the additional collection of time series data (step 702). In step 702, the additional collection of time series data is processed to determine a set of scaled first order differences from which an additional set of binned values can be determined.

A determination is made as to whether the correlation between the additional collection of time series data is within a threshold of the collection of time series data for the current product (step 704). When the highest correlation is within the threshold, the process places the additional collection of time series data into a current segment for the current product in segments (step 706). In step 706, the threshold is a value that is selected as having the lowest amount correlation that can be present for placing the additional collection of time series data into the segment in which the current product is located. The current segment can include the collection time series data for the current product or can also include one or more collections of time series data for other products and segmented with the current product.

The process creates a new forecasting model for the collections of time series data in the current segment when the additional collection of time series data is placed into the current segment (step 708). The process terminates thereafter

With reference again to step 704, if the highest correlation is not within the threshold, the process places the additional collection of time series data into a new segment (step 710). The process creates a new forecasting model for the additional collection of time series data in the new segment when the additional collection of time series data is placed into the new segment (step 712). The process terminates thereafter.

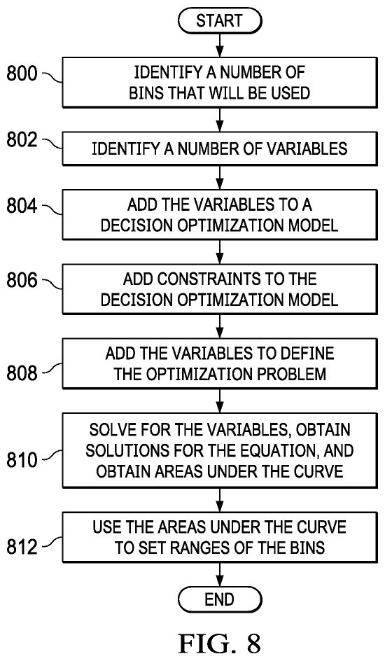

Turning now to FIG. 8, a flowchart of a process for creating bins with dynamic ranges is depicted in accordance with an illustrative embodiment. The process in FIG. 8 is an example of one manner in which step 504 in FIG. 5 can be implemented.

The process begins by identifying a number of bins that will be used (step 800). The number of bins in step 800 can be determined in a number of different ways. In this illustrative example, the number of bins can be based on a default number, a user input, or an input from an application. For example, if six bins are identified, the bins can be labeled as −3, −2, −1, +1, +2, and +3.

The process identifies a number of variables (step 802). In step 802, a number of variables can be identified as follows:

number_variables=int(ceiling((bins/2)/2).

As depicted, ceiling(x) is a ceiling function which takes a real number x and outputs an integer that is greater than or equal to x. In other words, the ceiling function rounds up to the nearest energy. In this example, int(x) is an integer function that takes the real number x and outputs an integer that is less than or equal to x. In other words, the integer function rounds a real number down to the nearest integer. In this example, for 6 bins, the number variables, number_variables, is 2.

The process adds the variables to a decision optimization model (step 804). In this illustrative example, the two variables added can be var1 and var2. Decision optimization uses mathematical techniques to solve decision-making problems involving multiple decision variables, business constraints, and trade-offs. The problem in this example was modeled as a decision optimization problem as explained above.

The process adds constraints to the decision optimization model (step 806). In this example, the constraints can be, for example, var2>=var1; var1>=0.1; and var2*sqrt(stdev)<=1. The constraints added to the decision optimization model can be such that values add up to a consistent number. Symmetry can be employed to allow the same values for the plus side and the minus side. In one illustrative example, the equation constraint can be 2*var1+var2=bins/2=3 for 6 bins.

The process then adds the variables to define the optimization problem (step 808). For example, with 6 bins, the problem optimizes var2−var1.

The process solves for the variables, obtains solutions for the equation, and obtains areas under the curve (step 810). For example, the solution can be var1=0.5 and var 2=2.0, the area under the curve can then be determined at 0.5/6*100=8.33% of the data (bin values) in the bin and 2/6*100−33.33% of the data (bin values) in the bin. The process uses the areas under the curve to set ranges of the bins (step 812). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

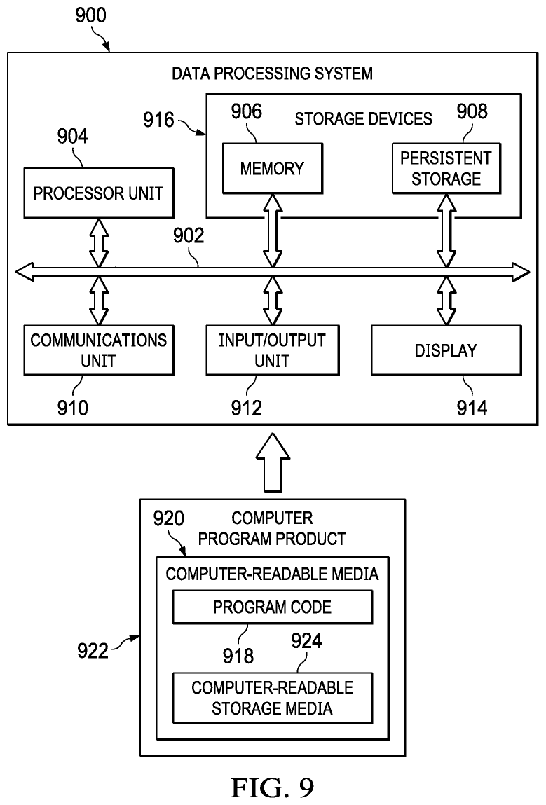

Turning now to FIG. 9, a block diagram of a data processing system is depicted in accordance with an illustrative embodiment. Data processing system 900 can be used to implement computer system 106 in FIG. 1. In this illustrative example, data processing system 900 includes communications framework 902, which provides communications between processor unit 904, memory 906, persistent storage 908, communications unit 910, input/output (I/O) unit 912, and display 914. In this example, communications framework 902 takes the form of a bus system.

Processor unit 904 serves to execute instructions for software that can be loaded into memory 906. Processor unit 904 includes one or more processors. For example, processor unit 904 can be selected from at least one of a multicore processor, a central processing unit (CPU), a graphics processing unit (GPU), a physics processing unit (PPU), a digital signal processor (DSP), a network processor, or some other suitable type of processor. Further, processor unit 904 can may be implemented using one or more heterogeneous processor systems in which a main processor is present with secondary processors on a single chip. As another illustrative example, processor unit 904 can be a symmetric multi-processor system containing multiple processors of the same type on a single chip.

Memory 906 and persistent storage 908 are examples of storage devices 916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 916 may also be referred to as computer-readable storage devices in these illustrative examples. Memory 906, in these examples, can be, for example, a random-access memory or any other suitable volatile or non-volatile storage device. Persistent storage 908 may take various forms, depending on the particular implementation.

For example, persistent storage 908 may contain one or more components or devices. For example, persistent storage 908 can be a hard drive, a solid-state drive (SSD), a flash memory, a rewritable optical disk, a rewritable magnetic tape, or some combination of the above. The media used by persistent storage 908 also can be removable. For example, a removable hard drive can be used for persistent storage 908.

Communications unit 910, in these illustrative examples, provides for communications with other data processing systems or devices. In these illustrative examples, communications unit 910 is a network interface card.

Input/output unit 912 allows for input and output of data with other devices that can be connected to data processing system 900. For example, input/output unit 912 may provide a connection for user input through at least one of a keyboard, a mouse, or some other suitable input device. Further, input/output unit 912 may send output to a printer. Display 914 provides a mechanism to display information to a user.

Instructions for at least one of the operating system, applications, or programs can be located in storage devices 916, which are in communication with processor unit 904 through communications framework 902. The processes of the different embodiments can be performed by processor unit 904 using computer-implemented instructions, which may be located in a memory, such as memory 906.

These instructions are referred to as program code, computer usable program code, or computer-readable program code that can be read and executed by a processor in processor unit 904. The program code in the different embodiments can be embodied on different physical or computer-readable storage media, such as memory 906 or persistent storage 908.

Program code 918 is located in a functional form on computer-readable media 920 that is selectively removable and can be loaded onto or transferred to data processing system 900 for execution by processor unit 904. Program code 918 and computer-readable media 920 form computer program product 922 in these illustrative examples. In the illustrative example, computer-readable media 920 is computer-readable storage media 924.

In these illustrative examples, computer-readable storage media 924 is a physical or tangible storage device used to store program code 918 rather than a medium that propagates or transmits program code 918.

Alternatively, program code 918 can be transferred to data processing system 900 using a computer-readable signal media. The computer-readable signal media can be, for example, a propagated data signal containing program code 918. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 920” can be singular or plural. For example, program code 918 can be located in computer-readable media 920 in the form of a single storage device or system. In another example, program code 918 can be located in computer-readable media 920 that is distributed in multiple data processing systems. In other words, some instructions in program code 918 can be located in one data processing system while other instructions in program code 918 can be located in one data processing system. For example, a portion of program code 918 can be located in computer-readable media 920 in a server computer while another portion of program code 918 can be located in computer-readable media 920 located in a set of client computers.

The different components illustrated for data processing system 900 are not meant to provide architectural limitations to the manner in which different embodiments can be implemented. In some illustrative examples, one or more of the components may be incorporated in or otherwise form a portion of, another component. For example, memory 906, or portions thereof, may be incorporated in processor unit 904 in some illustrative examples. The different illustrative embodiments can be implemented in a data processing system including components in addition to or in place of those illustrated for data processing system 900. Other components shown in FIG. 9 can be varied from the illustrative examples shown. The different embodiments can be implemented using any hardware device or system capable of running program code 918.

Thus, illustrative embodiments of the present invention provide a computer-implemented method, computer system, and computer program product for demand forecasting. In the illustrative example, collections of time series data for products are placed into segments. Each of the segments can be used to generate a forecasting model used to predict demand for products within the segment. In one illustrative example, sets of first order differences are determined by a computer system for time series data within the collections of time series data for the products. The sets of first order differences identify how values in the time series data within the collections of time series data change over time. The sets of first order differences for the time series data are normalized by the computer system to form sets of scaled first order differences such that a same scale is present between the sets of scaled first order differences. Bins with dynamic ranges are determined by the computer system for the sets of scaled first order differences, wherein the dynamic ranges are based on a distribution of the sets of scaled first order differences. The sets of scaled first order differences are placed into the bins by the computer system to form sets of binned values for the collections of time series data in which binned values in the sets of binned values are based on a number of scaled first order differences in the bins. The collections of time series data for the products are grouped into segments by the computer system based on a correlation between the sets of binned values for the collections of time series data.

In this manner, data in the collections of time series data can be segmented with a forecasting model being created for each segment of data. Thus, the illustrative embodiments provide an automated system for demand forecasting in which segmentation can be performed using bins with dynamic ranges as described in the illustrative examples.

In illustrative example, the first order difference is extracted to determine how the values are changing from time period to time period instead of just comparing across absolute values as with current techniques. Further, the illustrative example normalizes these values to express their relative magnitude of change over time. The first order differences are then placed into bins using dynamic range binning in an automated fashion to isolate the extreme changes in the time series. The dynamic range can be dynamically selected to have sizes to achieve desired results such as isolating changes that are greater than desired in the collections of time series data as determined from sets of scaled first order differences. Further, the binning of data in bins with dynamic ranges also can be used to reduce the granularity of the data. The correlation between the bin data is determined, and products that have a desirable correlation can be grouped into segments for use in building forecasting models on a per segment basis.

The forecasting models created using the data in the segments can enable better forecasting of demand for products. With improved forecasting abilities, companies with supply chains can increase the efficiency in which inventory is managed. This type of forecasting can be used in various industries including retail, software, industrial, automobile manufacturing, pharmaceutical, and other industries.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for demand forecasting, the method comprising:
determining, by a computer system, sets of first order differences for time series data within collections of time series data for products, wherein the sets of first order differences identify how values in the time series data within the collections of time series data change over time;
normalizing, by the computer system, the sets of first order differences for the time series data to form sets of scaled first order differences such that a same scale is present between the sets of scaled first order differences;
determining, by the computer system, bins with dynamic ranges for the sets of scaled first order differences, wherein dynamic ranges are based on a distribution of the sets of scaled first order differences;
placing, by the computer system, the sets of scaled first order differences into the bins to form sets of binned values for the collections of time series data in which binned values in the sets of binned values are based on a number of scaled first order differences in the bins; and
grouping, by the computer system, the collections of time series data for the products into segments based on a correlation between the sets of binned values for the collections of time series data.

2. The method of claim 1 further comprising:
creating, by the computer system, forecasting models for the products from the segments in which the collections of time series data are located.

3. The method of claim 1, wherein determining, by the computer system, the bins with dynamic ranges for the sets of scaled first order differences, wherein the dynamic ranges are based on the distribution of the sets of scaled first order differences comprises:
determining, by the computer system, the bins with the dynamic ranges based the distribution of the sets of scaled first order differences, wherein the dynamic ranges are selected to optimize an outcome of a set of variables under a set of constraints in a decision optimization model such that changes in first order differences greater than a threshold are isolated by the bins.

4. The method of claim 1, wherein grouping, by the computer system, the collections of time series data for the products into the segments based on the correlation between the sets of binned values for the collections of time series data comprises:
grouping, by the computer system, the collections of time series data for the products into initial groups based on correlation values for the sets of binned values for the collections of time series data being with a selected threshold of each other; and
creating, by the computer system, subgroups from the initial groups based on slopes for the collections of time series data in the initial groups, wherein the subgroups form the segments.

5. The method of claim 1 further comprising:
identifying, by the computer system, an additional collection of time series data for an additional product;
identifying, by the computer system, a current product in the products with a set of binned values having a highest correlation to an additional set of binned values for a set of scaled first order differences for the additional collection of time series data;
placing, by the computer system, the additional collection of time series data into a current segment for the current product in the segments when the highest correlation is within a threshold; and
placing, by the computer system, the additional collection of time series data into a new segment when the highest correlation is not within the threshold.

6. The method of claim 5 further comprising:
creating, by the computer system, a new forecasting model for the collections of time series data in the current segment when the additional time series data is placed into the current segment.

7. The method of claim 5 further comprising:
creating, by the computer system, a new forecasting model for an additional collection of time series data in the new segment when the additional collection of time series data is placed into the new segment.

8. A demand forecasting system comprising:
a computer system that operates to:
determine sets of first order differences for time series data within collections of time series data for products, wherein the sets of first order differences identify how values in the time series data within the collections of time series data change over time;
normalize the sets of first order differences for the time series data to form sets of scaled first order differences such that a same scale is present between the sets of scaled first order differences;
determine bins with dynamic ranges for the sets of scaled first order differences, wherein the dynamic ranges are based on a distribution of the sets of scaled first order differences;
place the sets of scaled first order differences into the bins to form sets of binned values for the collections of time series data in which binned values in the sets of binned values are based on a number of scaled first order differences in the bins; and
group the collections of time series data for the products into segments based on a correlation between the sets of binned values for the collections of time series data.

9. The demand forecasting system of claim 8, wherein the computer system operates to:
create forecasting models for the products from the segments in which the collections of time series data are located.

10. The demand forecasting system of claim 8, wherein in determining the bins with the dynamic ranges for the sets of scaled first order differences, wherein the dynamic ranges are based on the distribution of the sets of scaled first order differences, the computer system operates to:
determine the bins with the dynamic ranges based the distribution of the sets of scaled first order differences, wherein the dynamic ranges are selected to optimize an outcome of a set of variables under a set of constraints in a decision optimization model such that changes in first order differences greater than a threshold are isolated by the bins.

11. The demand forecasting system of claim 8, wherein in grouping the collections of time series data for the products into the segments based on the correlation between the sets of binned values for the collections of time series data, the computer system operates to:
group the collections of time series data for the products into initial groups based on correlation values for the sets of binned values for the collections of time series data being with a selected threshold of each other; and
create subgroups from the initial groups based on slopes for the collections of time series data in the initial groups, wherein the subgroups form the segments.

12. The demand forecasting system of claim 8, wherein the computer system operates to:
identify an additional collection of time series data for an additional product;
identify a current product in the products with a set of binned values having a highest correlation to an additional set of binned values for a set of scaled first order differences for the additional collection of time series data;
place the additional collection of time series data into a current segment for the current product in the segments when the highest correlation is within a threshold; and
place the additional collection of time series data into a new segment when the highest correlation is not within the threshold.

13. The demand forecasting system of claim 12, wherein the computer system operates to:
create a new forecasting model for the collections of time series data in the current segment when the additional collection of time series data is placed into the current segment.

14. The demand forecasting system of claim 12, wherein the computer system operates to:
create a new forecasting model for the additional collection of time series data in the new segment when the additional collection of time series data is placed into the new segment.

15. A computer program product for demand forecasting, the computer program product comprising:
a computer-readable storage media;
first program code, stored on the computer-readable storage media, executable by a computer system to cause the computer system to determine sets of first order differences for time series data within collections of time series data for products, wherein the sets of first order differences identify how values in the time series data within the collections of time series data change over time;
second program code, stored on the computer-readable storage media, executable by the computer system to cause the computer system to normalize the sets of first order differences for the time series data to form sets of scaled first order differences such that a same scale is present between the sets of scaled first order differences;
third program code, stored on the computer-readable storage media, executable by the computer system to cause the computer system to determine bins with dynamic ranges for the sets of scaled first order differences, wherein the dynamic ranges are based on a distribution of the sets of scaled first order differences;
fourth program code, stored on the computer-readable storage media, executable by the computer system to cause the computer system to place the sets of scaled first order differences into the bins to form sets of binned values for the collections of time series data in which binned values in the sets of binned values are based on a number of scaled first order differences in the bins; and
fifth program code, stored on the computer-readable storage media, executable by the computer system to cause the computer system to group the collections of time series data for the products into segments based on a correlation between the sets of binned values for the collections of time series data.

16. The computer program product of claim 15 further comprising:
sixth program code, stored on the computer-readable storage media, executable by the computer system to cause the computer system to create forecasting models for the products from the segments in which the collections of time series data are located.

17. The computer program product of claim 15, wherein the third program code comprises:
program code, stored on the computer-readable storage media, executable by the computer system to cause the computer system to determine the bins with the dynamic ranges based the distribution of the sets of scaled first order differences, wherein the dynamic ranges are selected to optimize an outcome of a set of variables under a set of constraints in a decision optimization model such that changes in first order differences greater than a threshold are isolated by the bins.

18. The computer program product of claim 15, wherein the fifth program code comprises:
program code, stored on the computer-readable storage media, executable by the computer system to cause the computer system to group the collections of time series data for the products into initial groups based on correlation values for the sets of binned values for the collections of time series data being with a selected threshold of each other; and
program code, stored on the computer-readable storage media, executable by the computer system to cause the computer system to create subgroups from the initial groups based on slopes for the collections of time series data in the initial groups, wherein the subgroups form the segments.

19. The computer program product of claim 15 further comprising:
sixth program code, stored on the computer-readable storage media, executable by the computer system to cause the computer system to identify an additional collection of time series data for an additional product;
seventh program code, stored on the computer-readable storage media, executable by the computer system to cause the computer system to identify a current product in the products with a set of binned values having a highest correlation to an additional set of binned values for a set of scaled first order differences for the additional collection of time series data;
eighth program code, stored on the computer-readable storage media, executable by the computer system to cause the computer system to place the additional collection of time series data into a current segment for the current product in the segments when the highest correlation is within a threshold; and
ninth program code, stored on the computer-readable storage media, executable by the computer system to cause the computer system to place the additional collection of time series data into a new segment when the highest correlation is not within the threshold.

20. The computer program product of claim 19 further comprising:
tenth program code, stored on the computer-readable storage media, executable by the computer system to cause the computer system to create a new forecasting model for the collections of time series data in the current segment when the additional collection of time series data is placed into the current segment; and
eleventh program code, stored on the computer-readable storage media, executable by the computer system to cause the computer system to create a new forecasting model for the additional collection of time series data in the new segment when the additional collection of time series data is placed into the new segment.
